(19) United States
(12) Patent Application Publication
(10) Pub. No.: US 2005/0082243 A1
(43) Pub. Date: Apr. 21, 2005

(54) Tip stand

(75) Inventors: Arto Lahti, Tuusula (FI); Tuomo Tiilikainen, Joensuu (FI)

Correspondence Address: OBLON, SPIVAK, MCCLELLAND, MAIER & NEUSTADT, P.C., 1940 DUKE STREET, ALEXANDRIA, VA, 22314, US

(73) Assignee: THERMO ELECTRON OY, Vantaa (FI)

(21) Appl. No.: 10/937,772

(22) Filed: Sep. 10, 2004

(30) Foreign Application Priority Data
Sep. 11, 2003 (FI) 20031302

(51) Int. Cl. B01L 3/00

(52) U.S. Cl. 211/74; 422/104; 211/85.11; 422/99; 422/100; 206/562; 206/558

(57) ABSTRACT

The invention relates to a stand for pipette tips, comprising a base and a lid which provide a closed box. Between the base and the lid is a packing, which extends around a joint constituted thereby and is made of a material softer than that used for the base and the lid. This makes it possible to achieve air tightness required by sterility.

### TECHNICAL FIELD

The invention concerns liquid handling technology and relates to pipette tip stand comprising a base and a lid.

### BACKGROUND ART

Pipettes are provided with separate tip containers called tips, into which to be dispensed is aspirated. Tips can be attached to a pipette by hand. However, tip stands are also used, which retain the tips in an upright position and from which a tip is picked up for a pipette by pressing the end of a pipette into the tip. This requires just one hand, with no manual contact with the tips during the engagement process. In case of a multichannel pipette, tips are arranged in the stand to match the spacing of tips in the pipette. Consequently, the engagement of tips proceeds substantially more quickly as all tips can be secured to a pipette in a single one-time procedure.

In manufacturing, tips may be packed loosely in bags. Such tips can be attached to a pipette by hand or placed first in a stand.

Tips may also be packed directly in stands by a manufacturer. This facilitates the use thereof. The stand can be placed in a box with a closing lid.

Sterile tips are required in many applications. Tip manufacturers commonly sterilize the tips by irradiation. After sterilization, tips must be kept in an absolutely sealed container. For irradiation, tip boxes are usually put into a plastic bag which is closed by heat sealing. The sealed bag is irradiated and not opened until the tips are picked up for use. Boxes have also been used, in which the lid is tightly sealed with an adhesive tape extending around the box. However, the reliable placing and removal of a tape is inconvenient. Tips can also be steam sterilized by the actual customer. In this case, tips picked up from an autoclave must be protected as effectively as possible prior to use to avoid contaminations.

### GENERAL DESCRIPTION OF THE INVENTION

The present invention provides a stand for pipette tips as set forth in claim 1. Other claims disclose a few preferred embodiments for the invention.

The tip stand in accordance with the invention comprises a packing, which circles around the joint between the lid and the base of the box. The packing is made of a material softer than that of the base, and it seals hermetically the box. This provides a tightness necessary for sterility. The packing is preferably an integral part of one component of the box, whereby it can be manufactured from appropriate plastics in a single process by injection moulding. The box can be sterilized as such and stored without a separate extra container or closing means. Closing and opening the box is easy. After being opened, it can be closed tightly again.

The base can be provided with a support rack for holding tips in an upright position. The support rack may be a separate element or an integral part of the base. The support rack can be provided, for example, with holes or recesses (e.g. tapered) for placing the tips therein. When the support rack is a separate element, it is possible to use a packing capable of sealing both a gap between the lid and the support rack and a gap between the support rack and the base. In this particular case, the packing may be an integral part of the support rack.

The lid may be an element separate from or hinged to the base. The structure may be provided with a suitable locking organ for fastening the lid to the base. The locking organ may function for example on a snap-on principle, in which case it has a flexible locking tongue and a detent interlocking therewith. The packing may also function as a locking organ.

The lid may have such a connection with the base that the lid has its bottom edge set against the top edge of the base. In this case, the packing will be between the edges. The lid and the base may also be connected by a lap joint, especially such that the lid has its bottom edge placed outside the side wall of the base. In this case, the packing may be a part of one component, the other component being provided with a groove for fitting the packing in. In a lap joint, one of the components may be provided with a shoulder, the other component placing its edge against it. Thus, the packing may find itself between abutting side walls, between an edge and a shoulder or in a corner formed by a shoulder and a side wall. When the packing lies against the edge of one component, said packing may include laterally extending parts, such as, for example, parts pressing against a wall. These parts may also include sealing means, such as rebates.

The packing may be specifically a lip seal, comprising one or two lips or, if desirable, even a larger number of lips.

A closed stand, along with its tips, can be sterilized especially by irradiation. Sterilization can also be performed with the lid opened, for example by means of hot steam, the lid being closed after sterilization.

A sterilized stand may be fitted with a seal, which is not broken until the lid is opened. This provides an immediate visual indication as to whether the lid has already been opened after sterilization.

The lid and the base can be manufactured for example in suitable polyalkylene, such as polypropylene. A useful packing material can be, for example, some suitable thermoplastic elastomer applicable to injection moulding.

### DRAWINGS

The attached drawings constitute a part of the written description of the invention and illustrate examples of some ways of implementing the invention.

FIG. 1 shows a tip stand.

FIGS. 2-5 show examples of packings for the stand of FIG. 1.

FIG. 6 shows another tip stand.

FIGS. 7-10 show examples of a few packings for the stand of FIG. 6.

### DETAILED DESCRIPTION OF SOME EMBODIMENTS OF THE INVENTION

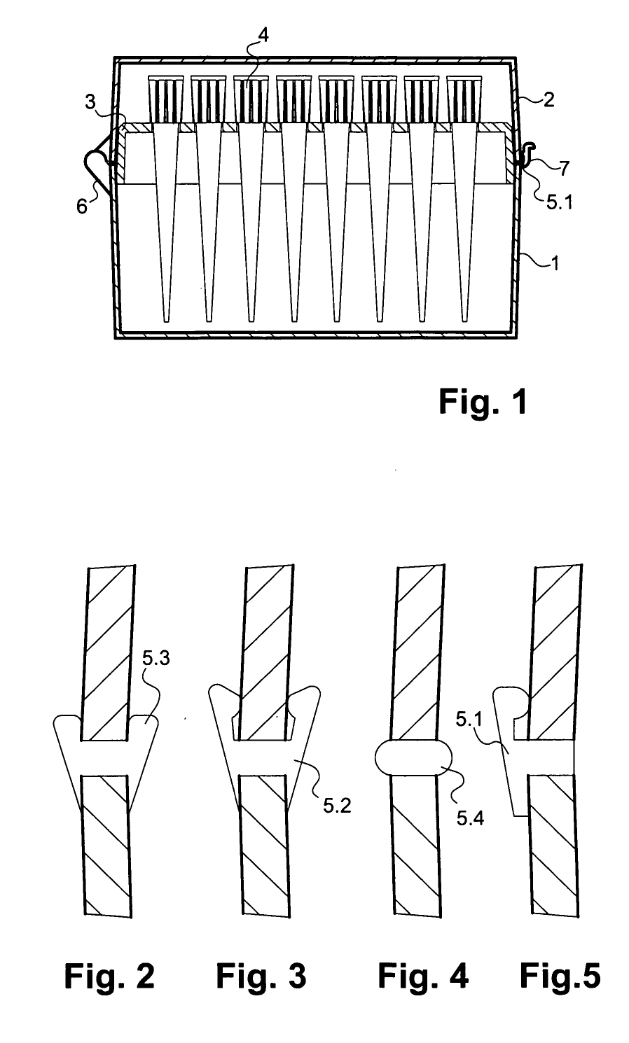

The tip stand of FIG. 1 comprises a base 1 and a lid 2 closing it tightly from above. The lid and the base settle edge to edge. The base includes a perforated plate 3 upon an internal ledge for placing tips 4 therein. The tips have a wider part at the top and holes in the plate are slightly larger than the bottom part of the tips. Thus, the tips are placed loosely in the stand and therefore easy to pick up. The stand components are manufactured in an appropriate plastic material by injection moulding.

A joint between the base 1 and the lid 2 is completely covered by a packing 5.1. The packing seals the joint as required by sterility. The packing 5.1 is made of a plastic material softer than that used for the base and the lid.

The packing 5.1 is an integral part of the base 1 and manufactured together with the base by injection moulding.

The packing 5.1 (FIG. 5) is provided with a sealing part to be placed between the edges of the base 1 and the lid 2 and a supporting part to be placed outside the walls and pressing against the walls. The supporting part includes a lower tab pressing against the wall of the base, and an upper tab provided with a lip pressing against the wall of the lid. The lower tab tapers towards its bottom edge but is relatively thick even at its bottom edge. The upper tab has its lip pressing substantially straight towards the wall.

FIGS. 2-4 illustrate some optional packings. A packing 5.2 includes a supporting part on either side of the walls. It has its lower tab tapering completely away by the time it reaches the bottom edge. The lip presses obliquely down towards the wall. A packing 5.3 has no separate lip in its upper tab. The tab tapers consistently from top to bottom. A packing 5.4 includes just a sealing part without supporting parts.

The lid 2 is hinged to the base 1 by means of a hinge 6. On the opposite side is provided a locking organ 7 for holding the lid closed. In this case, the locking organ includes a flexible tongue and a detent responding to its lip.

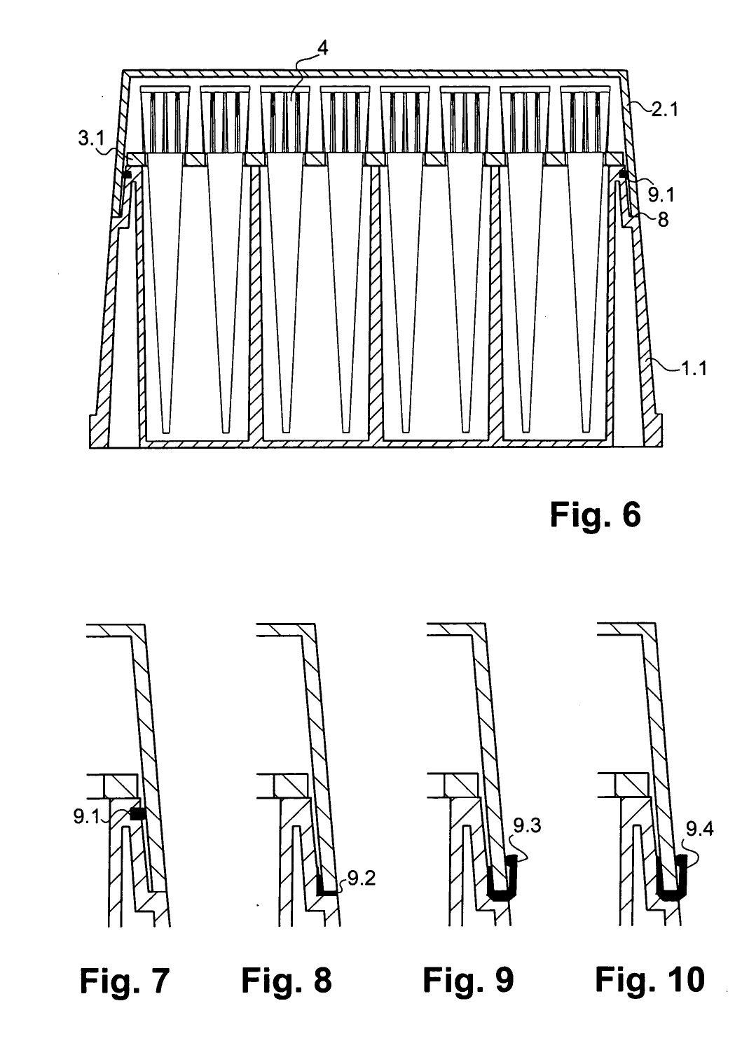

The stand of FIG. 6 is provided on the outer side near the top end of its base 1.1 with a shoulder 8, the bottom edge of a lid 2.1 responding thereto. Supported by side walls of the base and partitions included in the base is a perforated plate 3.1 for placing tips 4 therein. Between the side wall of the lid and the side wall of the base is a packing 9.1 (FIG. 7) made of a plastic material softer than that used for the base and the lid. The packing is in a groove extending around the wall of the base.

FIGS. 8-10 illustrate a few optional packings. A packing 9.2 includes both a horizontal part settling between the lid edge and the shoulder and a vertical part settling between the walls. As opposed to the packing 9.2, packings 9.3 and 9.4 are further provided with a leg extending against the outer side of the lid, having its top end provided with a lip pressing against the lid. In the packing 9.3, the section between the walls is of a lower height than the outer leg, while in the packing 9.4 it is approximately of equal height.

1. A stand for pipette tips, comprising a base and a lid to provide a closed box in which the tips are placed, between the base and the lid there a packing, which extends around the joint constituted by the base and the lid and which is made of a material softer than that of the base and the lid.

2. A stand as set forth in claim 1, wherein the packing comprises a sealing part set between the edges of the base and the lid, or the packing comprises a sealing part set between the side walls of the base and the lid.

3. A stand as set forth in claim 1, wherein the packing comprises a supporting part lining the wall of the base or the lid.

4. A stand as set forth in claim 1, wherein the base or the lid is manufactured from plastics by injection moulding.

5. A stand as set forth in claim 1, wherein the packing is an integral part of the base or the lid.

6. A stand as set forth in claim 1, wherein the stand includes a support rack for the tips.

7. A stand as set forth in claim 6, wherein the support rack carries sterile tips.

8. A stand as set forth in claim 7, wherein the tips have been placed in the support rack, after which the box has been closed and the tips have been sterilized.

9. A stand as set forth in claim 7, wherein the tips have been sterilized by irradiation.
